(19) United States
(12) Patent Application Publication
(10) Pub. No.: US 2021/0268748 A1
(43) Pub. Date: Sep. 2, 2021

(54) METHOD FOR INCREASING THE DOSING PRECISION OF MICROFLUIDIC PUMPS OR VALVES, AND WELDING APPARATUS AND TENSIONING APPARATUS FOR CARRYING OUT THE METHOD

(71) Applicant: m2p-labs GmbH, Baesweiler (DE)

(72) Inventors: Niklas FRISCHE, Geilenkirchen (DE); Alexander KREMERS, Baesweiler (DE); Karlheinz HILDENBRAND, Owingen (DE); Christoph PETRY, Neuss (DE)

(73) Assignee: m2p-labs GmbH, Baesweiler (DE)

(21) Appl. No.: 17/254,531

(22) PCT Filed: Nov. 29, 2019
(86) PCT No.: PCT/DE2019/000306

§ 371 Date: Dec. 21, 2020

(30) Foreign Application Priority Data
Dec. 19, 2018 (DE) 10 2018 009 860.6

(51) Int. Cl. B29C 65/16; B29C 65/48; B29C 65/72; B29C 65/00; F04B 43/04; F04B 13/00

(52) U.S. Cl. CPC B29C 65/1603; B29C 65/4835; B29C 65/72; B29C 66/02245; F16K 7/14; B29C 66/028; F04B 43/043; F04B 13/00; B29C 66/026

(57) ABSTRACT

The invention relates to a method for increasing the dosing precision of microfluidic pumps and valves based on a flexible cover film/diaphragm and a valve trough, in which the surface of the diaphragm facing the valve trough is heated with a laser beam.

The technical production of active substances, vitamins, peptides or proteins by genetically modified microorganisms has gained enormously in economic importance over the last three decades. In the industrial production of these substances, the producing cell systems are cultivated in a bioreactor that can hold many cubic metres of volume. This ensures that the cells can produce optimally by controlling the pH value, the concentration of nutrients, the oxygen content of the solution and some other parameters relevant to the growth and metabolism of the cells.

In general, control of vital parameters in a microorganism culture or cell culture requires these parameters to be measured in real time or at least in a timely manner using a suitable measuring method. A deviation of a vital parameter from the target value then requires appropriate intervention. This can be implemented fully automatically or manually by the operator. In both cases, an attempt is made to adjust the corresponding vital parameter to its target value by dosing a suitable agent. For example, a pH-value that decreases during cell cultivation is normally corrected by dosing an adequate amount of a suitable base; an increasing pH-value is corrected by adding an acid, accordingly. The energy supply of the microorganisms or cells is generally realised by controlled addition of a suitable carbon source, often glucose solution. It is often crucial here that the necessary agents are added in precisely measured quantities. An excess or shortfall of an agent can impair the product quality of the biotechnologically produced substance, bring production to a complete standstill, or at least compromise the space-time yield.

On a technical scale—i.e. when cells are cultivated in several hundred or even many thousand litres of culture fluid—the dosing of agents to adjust the culture conditions is not a particular problem, apart from the fact that the addition usually has to be carried out under completely sterile conditions: the required amount of agent is in the range of a few millilitres to litres, and thus there are a variety of techniques that allow the agents to be measured and dosed with high accuracy and precision.

However, the method described above of first establishing the culture conditions for biotechnological production usually requires other techniques during the product development, in which the vital parameters used during production must first be determined. During this optimisation process, potentially suitable organisms generated by random mutagenesis or targeted genetic manipulation are first screened. The most promising organisms are selected and in the next step the culture conditions are varied, first in broader steps, then increasingly in smaller steps. It is obvious to everyone that it does not make sense to carry out such optimisations on a scale of thousands, hundreds or even just a few litres. The costs of each individual optimisation experiment are substantially proportional to its scale. The costs for agents, equipment and space requirements in the laboratory correlate strongly with the culture volume. The time an operator has to devote to an individual culture also depends to a large extent on its volume.

It is therefore not surprising that scientists who optimise a cell or microorganism culture and biotechnical production, which often requires hundreds or thousands of different experiments, strive to carry out these experiments in parallel where possible and on the smallest possible scale, i.e. in a small volume.

For this reason, parallel microbioreactors are being used more and more frequently in biotechnology. The reactor vessels are often arranged in the form of a microtiter plate, which accordingly leads to an array of small or very small volume reactors. This makes it possible to run 6, 24, 48, 96, 384 or even 1536 cultures simultaneously in only one microtiter plate, often in the standard format of 128×85 mm Reaction conditions optimised in this microvolume can often be transferred into a macroscopic format with relatively small adaptations. By varying the number of reactors on a microtiter plate, the working volumes vary significantly accordingly: while even scales of less than 10 ml are usually referred to as microreactors, a further reduction of the volume to less than 1 mL, less than 500 μL, 100 μL or even less than 10 μL allows considerable time and cost savings, especially when optimising culture conditions with several manipulated variables, due to the possibility to carry out the experiments in parallel. However, the dosing of agents, often referred to here as control agents, which are necessary to keep the culture conditions within the target range, often poses a great challenge. In reactors with volumes below 1 mL, the control agents usually have to be slowly dosed in μL or even nL volumes without any significant reduction in the requirements with regard to the accuracy and repeatability of the experiments as compared to the conditions in large reactors.

Many manufacturers therefore like to use proven technologies, such as syringe or peristaltic pumps, when developing technologies for the addition of control agents on a medium scale. These technologies allow a stable and reproducible delivery rate at least on a μL scale, with certain restrictions even on a nL scale. However, the use of these pumps in microbioprocess technology has the disadvantage that sterile conditions can generally only be guaranteed if tubes and syringes are thoroughly cleaned and sterilised before use or if they are used as appropriately prepared single-use articles. Setting up just one experiment is then associated with considerable cost and time, especially if the degree of parallelisation involves more than one or two dozen simultaneous cultures. Other manufacturers of microbioreactors use high-precision dosing valves (Applikon) to feed liquids into the reaction chambers. Here too, the liquids come into contact with parts of the valves and these must therefore be cleaned and sterilised before use. In addition, such dosing must take place through the lid of the microtiter plate and thus must potentially break through the sterile barrier. A cost-effective and easy-to-use disposable system with delivery through the bottom of a microtiter plate would therefore be of considerable benefit to the user of microbioreactors.

An interesting method for conveying highly parallel control agents in microbioreactors is described in the European patent EP3055065: By means of a microfluidic system consisting of channels of about 100 μm diameter and pumps and valves integrated into these channels, control agents can be pumped from reservoirs integrated on a microtiter plate, through the bottom of a microtiter plate, into the microreactors. The use of microfluidic valves and pumps promises a good integratability of many individual microbioreactors into a microbioreactor system, thus enabling many parallel experiments within a relatively small installation space. By means of a large number of valves, pumps and channels, up to 32 reaction chambers, each with two dosing paths, can be controlled simultaneously, and thus processes with high throughput can be carried out. A higher number of up to approximately 2000 reaction chambers or more can also be realised with this technology.

The function of the pumps and valves integrated into the chip is based on the fact that mostly circular troughs connected to the channels are sealed with a flexible film or diaphragm. By means of air pressure, the film can be pressed into the troughs, which causes the channel to be interrupted and liquid to be pressed out of the trough. Depending on the arrangement of these troughs/valves in relation to each other and depending on the sequence and duration with which the film is pressed into these troughs/valves, liquid can be pumped in a defined direction at flow rates that are defined in principle.

Such microfluidic valves and pumps (diaphragm pumps) are now regularly used in the life science sector, as they can be actuated simply and relatively inexpensively using compressed air. If a pump chamber is placed between two valves, a peristaltic movement of the liquid can be achieved by a certain switching sequence, which allows a quasi-continuous movement of the liquid without the physical properties of the liquids having a significant influence on the pumping performance Only at low flow rates does the delivery of the pumps become visibly discontinuous, since the volume of the pump chamber is the smallest discrete volume of liquid that can be moved in a unit of time. The challenge of this technology lies in the covering of the valve trough with a flexible diaphragm. A wide variety of methods are used here, which can be divided in principle into indirect (adhesive connection or clamping) and direct connection techniques (adhesive bonding, solvent-based bonding, thermal welding or ultrasonic welding) (Tsao et al. 2008).

The most common method of covering the valve trough is thermofusion or thermal welding of the diaphragm to the main body by means of increased temperature or ultrasound and pressure. This method does not require any other additives that could leak out and be harmful to the cells. Before the clamping, it has the advantage of not requiring any mechanical aids. In thermal welding, the substrates are brought close to their glass transition temperature and pressed together with the help of a pressing punch. The interaction of pressure and temperature generates sufficient polymer flow to create interdiffusion between polymer chains of the individual layers, thus creating a strong connection similar to the cohesive connection strength of the base material. A major challenge in thermofusion, however, is the reduction of structural deformation: In order to precisely cover valves or pump chambers with a flexible diaphragm, the valves must have defined edges to which the diaphragm is joined. This means that these valves or pump chambers must be relatively deep in order to avoid significant structural deformation caused by heating and pressing on the film. In order to enable low delivery volumes, the design of the geometry of the valves is therefore usually based on small cross-sectional areas with a relatively high depth and thus a high dead volume, which makes it more difficult to seal the valves. On the other hand, to achieve a low leakage rate with low dead volume, it would be helpful to achieve a large width to depth ratio of the valve: The wider the valve, the less pneumatic pressure is needed to press the cover film into the valve during operation, thus sealing or filling the valve or, in the case of a pump, to convey the entire volume. Unfortunately, it is much more difficult to thermally weld the cover film onto these wide and flat valve troughs than it is with the deep troughs described above. Due to its flexibility and its own weight, the diaphragm film can lay itself into the valves and also stick there. This results in unevenly covered valves and pump chambers. The result is pump valves with a high variance in the volume of the pump chamber. This has a negative effect on the reproducibility of the pumping process from pump to pump: Since the pump's delivery volume is directly proportional to the chamber volume, a variable chamber volume directly means a lower reproducibility of the dosing process or a lower delivery precision from pump to pump.

In order to thermally weld a flexible film onto flat valves (large diameter, shallow depth), it has therefore proved to be helpful to perform the welding process, which is characterised by elevated temperature and pressure, with the aid of a heated punch that has recesses at the location of the valve and pump chamber cavities. This reduces the heat transfer into the valve trough, which means that flexible films in the valve trough stick together less easily and the edges of the valve troughs are deformed less easily. In practice, however, it has been shown that the heat transfer into the pump chamber cannot always be reduced to such an extent that the sticking of the flexible film in the chamber is not completely eliminated. On the other hand, valve recesses in the joining punch require the punch to be aligned extremely precisely in relation to the valve troughs. Regardless of the problems generally associated with the mechanical alignment of two components relative to each other, even a slightly uneven heating of the joining punch can result in anisotropic expansion in different directions. The consequence is that the valve troughs in a microfluidic chip and the recesses in the joining punch, even with perfect mechanical alignment, do not always lie concentrically. Similarly to valves with partially glued-on cover diaphragm, this can also lead to a considerable variance in the volume of the pump chamber. Here, too, the pumping performance shows a considerable variance from pump to pump.

Even if microfluidic pump systems with flexible cover film are in principle well suited for use in microbioreactors for the above-mentioned reasons (excellent parallelisability, easy sterilisability, low costs, simple use in a single-use article/disposable), the high variance in the delivery rate of different pumps of identical design according to the current prior art means that their use for screening organisms or optimising conditions in cell cultures is not possible if the system reacts sensitively to slight changes in culture conditions. These systems require more precise dosing systems.

The invention relates to a method for increasing the dosing precision of microfluidic pumps and/or valves based on a flexible cover film, referred to as a diaphragm, and a valve trough according to claim 1.

Advantageous refinements are the subject of the dependent claims.

It is therefore advantageous if the diaphragm is welded to the valve body by means of the laser beam. Furthermore, the diaphragm or the valve body can be provided with a heat-activatable adhesive. It makes sense to use the beam to attach the diaphragm to the valve body as a seam along the edge of the valve trough. The surface of the diaphragm facing the valve trough can be heated by radiation impinging on the diaphragm. This is particularly easy if the radiation impinges on the surface through the diaphragm. However, the radiation can also hit the surface through the valve body. In order to achieve a particularly smooth surface against which the diaphragm is in contact, the surface of the valve body can be polished before the attachment. The surface of the valve body may have been plasma etched before the attachment, etched with an ion beam, smoothed by chemical modification and/or the surface of the valve body may have been hydrophilised before the attachment. The aim here is to ensure that the surface of the valve body has a mean roughness value (Ra value) of less than 100 nm, preferably less than 50 nm and very preferably less than 20 nm before it is attached around the valve trough. To determine this measured value, the surface is scanned over a defined measuring distance and all differences in height and depth of the surface are recorded. After calculating the determined integral of this roughness curve over the measuring distance, the result is divided by the length of the measuring distance.

The pump should be used for pumping liquids with flow rates below 1 mL/h; but particularly with flow rates below 100 μL/h and very particularly in the range of 0.01 to 80 μL/h. It is also advantageous if the pump is used to deliver liquids with a pump volume per pump stroke between 5 nL/stroke and 1/stroke, but particularly with a pump volume between 25 nL/stroke and 500 nL/stroke and very particularly in the range of 75 to 250 nL/stroke. The reduced pump-to-pump variance of the delivery rate compared to a pump produced by thermofusion with a heated joining punch is achieved by welding the upper side of the valve trough with a flexible diaphragm using a laser beam. The inaccuracy of the guidance of the laser beam in the x-y direction should be less than 1 millimetre, preferably less than 50 micrometres and very preferably less than 5 micrometres. In order to be able to weld also cover films/diaphragms made of transparent polymers on valve troughs which are likewise made of transparent polymers, which allows optical measurements in different parts of the spectrum within the pump or around the pump, different polymers with different transmission ranges can be used, which are welded with UV lasers, visible laser beams or with infrared lasers. The preferred wavelength range of such a laser is between 0.1 and 1000 micrometres, preferably between 0.4 and 50 micrometres and very preferably between 0.78 and 3 micrometres. In this spectral range (near infrared), many polymers have characteristic absorption bands and can thus be heated by a focused laser beam beyond their softening point at precisely defined points without using additional absorbers in the plastic or on the plastic surface (absorber-free transmission welding). Plastics such as polystyrene or ethylene-norbornene copolymers (COC or COP), which are highly transparent to visible light, can also be welded without absorbers. The power of the laser beam is between 0.01 and 1000 watts, preferably between 0.1 and 100 watts and very preferably between 3 and 50 watts.

The advantage of welding diaphragm film and valve trough with a laser instead of thermally joining them with a joining punch is that the laser can be adjusted much better than a heated joining punch and that the welding process does not take place over a large area, but is limited to a line of a seam whose geometry and course can be determined by an exact guidance of the laser with an x-y imprecision of less than 3 μm. The width of the weld seam here is less than 1 millimetre, preferably between 250 and 20 micrometres. It is advantageous if the attachment is performed over a line whose width is 20 micrometres to 3 millimetres, preferably between 30 and 500 micrometres and particularly preferably between 50 and 300 micrometres. Due to the precise guidance of the laser and the small seam width, the decentring of the valve trough and the border between welded and non-welded diaphragm film, which is difficult to avoid in the case of thermal bonding with joining punches, as well as the sticking of the diaphragm film in the valve trough due to unintentional welding are avoided.

The precise guidance of the weld seam and the resulting low heat input into the valve trough, however, does not always prevent non-thermal bonding of the diaphragm film and valve trough. This is particularly true if the thickness of the valve film is greater than the depth of the valve trough or if the thickness of the film and the depth of the trough are at least of a similar order of magnitude. In this case, pressing the pre-tensioned film onto the plastic chip, which is preferred for a strong weld, can result in the diaphragm film also being pressed into the valve trough. While a precise, local guidance of the laser beam and an exact dosage of its power reliably prevents welding of the film in the valve trough, the hydrophilic interaction of the less polar surface of the valve trough in the plastic chip and the equally less polar surface of the diaphragm film can cause the film and chip to adhere to each other. A possible electrostatic charge of the less electrically conductive surfaces can also promote such adhesion. Furthermore, the roughness of the surface of the valve trough, which can look like an uneven sandpaper when observed with a microscope with suitable magnification, can cause a relatively soft diaphragm film to become entangled with these sandpaper-like structures when pressed for welding onto this microscopic roughness of the valve trough. All of the above effects, alone or in combination, can lead to an interaction between the diaphragm film and the valve trough causing the pumping process to be hindered. This can result in a reduced pumping performance or failure of the diaphragm pump. In contrast to an accidental thermal welding of valve trough and diaphragm film, which is a frequent side effect especially in the case of the thermal bonding/welding with a heated metal punch described above, the interactions between diaphragm and film described in the case of laser welding are at least partially reversible. They can therefore be partially reversed during the pumping process. Nevertheless, the strength with which the diaphragm film and valve trough can interact is sometimes so substantial that suitable countermeasures must be taken.

A fundamentally simple method to reduce the mechanical interactions between chip and diaphragm film, which can result from the micro-roughness of the valve trough, is to smooth the surface of the valve troughs. Since the chip with its valve troughs is preferably produced by injection moulding, it is therefore particularly suitable to smooth the valve troughs in the injection mould, which in principle represent easily accessible convex structures there, by polishing. In this way, roughnesses can be reduced to a fineness of a few nanometres. The interactions of diaphragm film and valve trough can thus be significantly reduced compared to the interactions produced by a chip whose corresponding injection mould has only been milled and smoothed. Although very simple in principle, the manual demands on the fine polishing of an injection mould made of metal—sometimes hard metal—in the nanometre range are very high. Smoothing the valve troughs on the chip body is technically less demanding. Due to the much softer material used here, usually polystyrene, polyolefin or another plastic, polishing the valve troughs is easier than polishing the injection mould—but at the price of having to rework every single injected chip and not just one mould. Apart from polishing, the surface in the valve troughs of the chips can also be chemically smoothed. Here, it is preferred to use solvents, which attack the polymer from which the chip is made to a limited extent. Fine structures, such as the micro-grain of a valve trough, can thus be levelled. For polyolefin chips, mixtures of tetrahydrofuran (THF) with water (preferably 5 to 70% THF content) or mixtures of methyl ethyl ketone (MEK) with water (preferably 5 to 25% MEK content) are used. For polystyrene, isopropanol mixed with water is recommended. In general, a mixture of a solvent that attacks the polymer from which the valve trough is made and a solvent to which the valve trough is resistant should be used. This allows mixtures to be produced to which the valve trough is relatively resistant but not inert. In this way, the very fine structures that cause the roughness of the valve trough can be smoothed without significantly compromising the much coarser structures that represent the channels in the chip and the cavities of the valve troughs. Solvent mixtures containing components that are not miscible with water can also be used to smooth the valve troughs. Mixtures of chlorinated solvents, such as chloroform or dichloromethane with ethanol or isopropanol are particularly suitable for smoothing the surfaces of polyolefins. Physicochemical methods such as plasma etching can also be used to level the valve troughs after injection moulding or of individually milled chips and valves. Here, the chip with the valves is exposed in a vacuum (0.001 to 0.1 mbar) to an oxygen plasma or air plasma generated by high voltage. In the process, the fine roughnesses are oxidatively attacked and thus smoothed. In addition, the plasma causes the deposition of oxygen radicals on the polymer surface and the formation of oxidation products of the polymer. In particular, carboxylic acids, alcohols, aldehydes, ketones, epoxides, oxetanes, peroxides and other partially poorly characterised radical oxygen adducts are formed. All these compounds, in addition to a possible smoothing of the surface of the valve cavities, cause a considerable increase in the polarity of the surface. This reduces hydrophobic interactions between diaphragm film and valve cavity and thus considerably reduces adhesion between valve and film.

Another very good method to reduce interactions between valve cavity and film is to coat the inside of the valves with polar chemical compounds. Detergents are particularly well suited for this purpose, as they bind firmly to the polymer surface of the valve trough with their lipophilic partial structure and, with their polar head group, reduce the adhesion of the valve film to the valve trough to almost zero. Anionic, cationic and neutral detergents are suitable for this purpose. Practically, these detergents are applied from an aqueous solution of the detergent at a concentration of 0.001 to 1%. To do this, the chip with the valve troughs is immersed briefly (for at least about one second) in the aqueous solution of the detergent. The lipophilic ends of the detergent automatically orient themselves on the surface of the chip/valve trough and form a dense layer, with the polar head groups of the detergent orienting themselves in the direction of the aqueous medium, from which the detergents diffuse from the solution towards the chip/valve trough. Suitable detergents for this purpose are conventional soaps, i.e. alkali salts of higher carboxylic acids, but especially polymeric carboxylic acids such as polyacrylates (Sigma-Aldrich), which adhere more firmly to the surface of the chip or valve trough due to their higher avidity. Equally suitable are sulphates or sulphonic acids such as sodium dodecyl sulphates (SDS, Sigma-Aldrich) or their polymeric analogues. Higher molecular natural substances such as lecithin or chemically purified lecithin-like compounds (e.g. phospholipon G90, Lipoid AG, Cologne) have also proven to be particularly suitable. The anionic functionality of these compounds is represented by a phosphate group. Suitable cationic polymers are quaternary ammonium salts with at least one higher alkyl radical (“invert soaps”) such as tetradecyltriammonium chloride. Similarly to the anionic polymers, the adsorption on the chip/valve trough can be increased here too by using polymeric structures. Polyethylene imine (Sigma-Aldrich) and higher molecular polyamines with or without quaternary amino groups have proven to be particularly suitable. Neutral detergents are also very suitable for the hydrophilic coating of the chip surface/valve trough. In addition to low-molecular compounds such as Tween 20 (Sigma-Alrich), the class of surfynols (e.g. Surfynol 61, Surfynol 104, Surfynol AD01, Surfynol AS 5020, Surfynol AS 5040, Surfynol AS 5060, Surfynol AS 5080, Surfynol AS 5180 as well as Tegoprene (Tegoprene 5840, Tegoprene 5860, Tegoprene 5885) has been proven to be suitable. The above-mentioned Surfynols and Tegoprene are all available from Evonik, Essen. Some of these compounds are water-soluble; in some cases it is recommended for the coating of the microfluidic chip to first prepare a stock solution of the neutral polymer with a concentration of about 10% in isopropanol and to then dilute with water to the target concentration of 0.001 to 1%.

As the detergent coating of the valve edge to which the diaphragm film is to be welded can lead to a reduced stability of the weld seam, it is recommended to avoid coating the valve edge or to reduce the thickness of the coating or to not weld the diaphragm film, but to hot-glue it instead. In any case, the very good dosability of the energy input and positioning accuracy of a laser should also be used for adhesive bonding, so that a hot-gluing process is preferable to conventional adhesive bonding.

A practicable method of restricting detergent coating to the inside of the valve body—i.e. not coating the entire chip surface hydrophilically—is to cover the valve region on the chip with an adhesive tape which is perforated in the position of the valve troughs. In this way, during plasma treatment of the chip, only the insides of the valve troughs are exposed to the oxygen or air plasma, while the valve edges are protected by the adhesive tape. Dipping the thus prepared chip into one of the detergent solutions mentioned above causes only the insides of the valve troughs to be hydrophilically coated, while the hydrophilic coating on the valve edges is removed by peeling off the protective adhesive tape. Subsequent welding is thus possible without any problems. The use of detergents which bind preferably on the plasma-activated part of the surface, but not on the part which remains native, allows the protective adhesive tape to be removed first after plasma activation and then the entire chip to be treated with detergent solution. Tegoprene 5840 is particularly suitable for this type of treatment—it mainly binds only on the plasma-activated part of the chip, thus allowing detergent treatment of the chip after removal of the protective adhesive tape without affecting the strength of the subsequent laser welding. This property of Tegoprene 5840 but also of Surfynole AS50xx makes it possible to dispense with adhesive tape when covering the valve edges during plasma activation and to use a rigid covering mask instead, which is easier to position but can only be treated partially or not at all together with the chip in the detergent solution. Other detergents such as Phospholipon G90 adhere similarly well to a plasma-activated as well as a non-plasma-activated chip, thus allowing hydrophilic coating without plasma activation.

For hot-gluing the chips, a film coated with heat-activatable adhesive should be used. Coating the chip body with adhesive only makes sense if the coating process ensures that as little as possible, but preferably no adhesive can penetrate the valve troughs. This makes the use of adhesive directly on the chip body possible but relatively elaborate. Coating the film with adhesive is therefore usually preferable to coating the chip body. For laser-activated hot-gluing of diaphragm film and chips, commercial hot-glue films can be used (e.g. MH-92824, 93025 or 92804; Adhesive Research, Dublin, Ireland) or polyolefin films coated with polyurethane-based hot glue (film: Denz BioMedical GmbH, Mader, Austria); adhesive: Dispercoll U53 blended with 7.5% Desmodur Ultra DA-L, both Covestro AG, Leverkusen). For bonding, the diaphragm film should have a thickness of 30 to 300 μm. About 100 μm are preferred. Adhesive layer thicknesses between 2 and 100 μm are practical. A thickness of about 7 μm is preferred. Due to post-crosslinking of Dispercoll and Desmodur after laser-assisted hot gluing, the adhesive seam should be cured for at least 12 hours before reaching the final strength.

Further, the invention relates to an apparatus in which a laser is moved in computer-controlled fashion with start and end coordinates being automatically recorded by a digital camera in such a way that the cover film/diaphragm is sealed at the correct positions in the vicinity of all valves and pumps. In addition, the invention relates to a tensioning apparatus to tension the cover film/diaphragm without wrinkles with the correct pre-stretch and flush with the valve upper side so that the pressure exerted by the film on the valve upper side is the same everywhere so as to achieve a uniform weld seam. In the case of multiple or numerous valve troughs integrated into a microfluidic chip, the tensioning apparatus according to the invention is capable of tensioning the lid film/diaphragm without wrinkles, with the correct pre-stretch and flush with the chip surface, so that the pressure exerted by the film on the chip surface is the same everywhere so as to achieve a uniform seal.

Further, the invention relates to a method and an apparatus for using the described pumps and valves for the individual dosing or discharge of small quantities of liquids or gases in micro-reactors and microreactor arrays, such as microtiter plates.

Embodiments are shown in the drawing and are described below. In the drawing

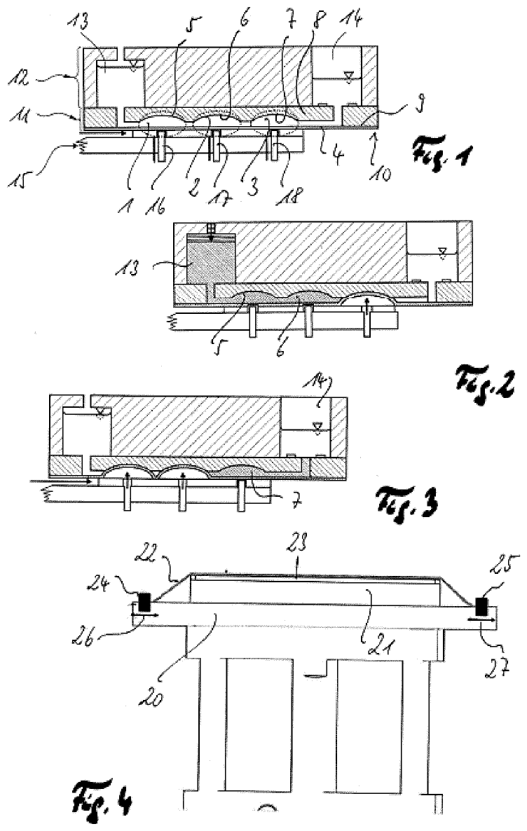

FIG. 1 shows a microfluidic pump with a plurality of valves and empty valve troughs,

FIG. 2 shows the pump shown in FIG. 1 with two filled valve troughs,

FIG. 3 shows the pump shown in FIG. 1 with a filled valve trough,

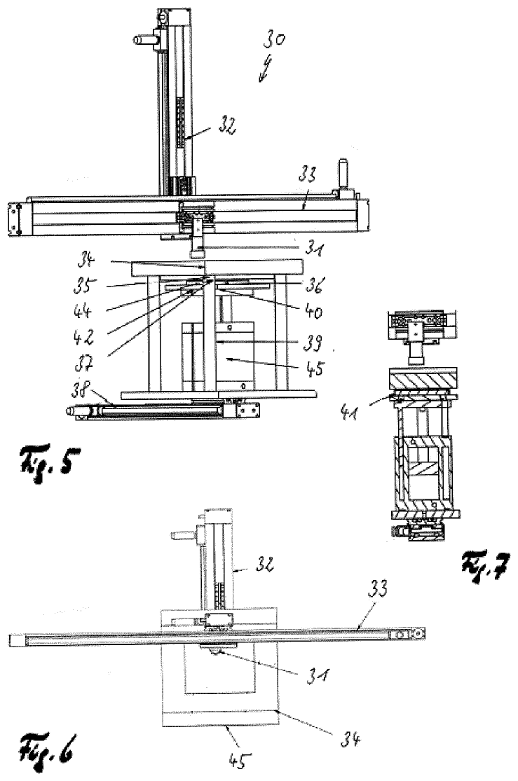

FIG. 4 shows a tensioning apparatus for applying a diaphragm,

FIG. 5 shows a side view of a welding apparatus,

FIG. 6 shows a plan view of the welding apparatus shown in FIG. 5,

FIG. 7 shows position of the adjusting screws on the welding apparatus shown in FIG. 5,

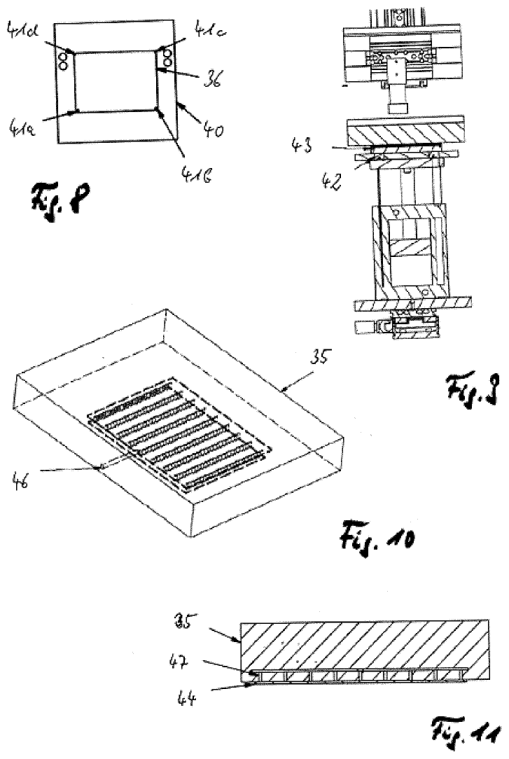

FIG. 8 shows the position of the adjusting screws shown in FIG. 7 in a plan view,

FIG. 9 shows the position of the force sensors and positioning pins on the welding apparatus shown in FIG. 5,

FIG. 10 shows a view of a glass vacuum chamber,

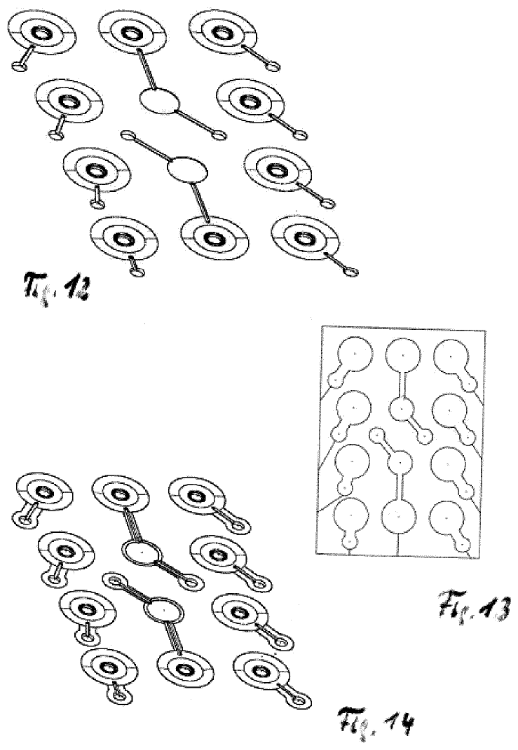

FIG. 11 shows a section through the vacuum chamber shown in FIG. 10,

FIG. 12 shows a valve contour without weld seam,

FIG. 13 shows a weld contour, and

FIG. 14 shows a valve contour with weld seam.

FIGS. 1 to 3 show a pumping sequence of a plurality of microfluidic pumps 1, 2, 3, in which a flexible diaphragm 4 covers valve troughs 5, 6, 7 of a valve body 8. To attach the flexible diaphragm 4 to the valve body 8, the surface 9 of the diaphragm 4 facing the valve troughs 5, 6, 7 was heated with a laser beam. Since in the present case a plurality of valve troughs 5, 6, 7 are located next to each other, the diaphragm 4 is only attached to the valve body 8 in the edge area 10.

In the embodiment, the valve body 8 is a microfluidic chip 11, above which a microtiter plate 12 is arranged. This microtiter plate 12 contains reservoirs 13 and wells 14. The microtiter plate 12 is moved by a shaking array 15, in which channels 16, 17, 18 of a pneumatic system acting on the diaphragm are arranged.

FIG. 2 shows how liquid flows from the reservoir 13 into the valve troughs 5 and 6, and FIG. 3 shows how liquid in the valve trough 7 is connected to the well 14.

FIG. 4 shows a piston table 20 with a positioning table 21 arranged above it, over which a diaphragm 22 is tensioned. The diaphragm 22 rests on a polymer main body 23 and is held on both sides by magnets 24 and 25, which can be moved along a rail in the direction of the arrows 26, 27 to tension the diaphragm 22.

The complete system of the apparatus for welding a valve trough or pump trough and the cover film/cover diaphragm is shown in FIG. 5: the welding apparatus 30 contains a radiation source 31 (e.g. thulium fibre laser) and an axis system with the axes 32 and 33, which makes it possible to move the tensioning apparatus in a plane, but at least in one direction, under the laser in order to generate a weld seam with a defined position. The tensioning apparatus itself makes it possible to attach at least one valve trough, but normally two or more valve troughs or pump troughs integrated in a chip/polymer body 37 to the movable axis system. A transparent flexible diaphragm 38 is also tensioned over the polymer main body 37. The tensioning apparatus consists of a cylinder 39 with piston table 40, a positioning table 36, at least four adjusting screws 41 and at least four force sensors 42. The force sensors 42 allow the film to be tensioned isotropically with the aid of a tensioning collar 34. The tensioning apparatus with polymer main body and tensioned diaphragm is pressed against a glass plate 35 by lifting the piston table. The glass plate thus exerts a pressure on the polymer main body with chip. By introducing the energy of the laser through the glass plate onto the diaphragm tensioned over the polymer main body, both diaphragm and polymer main body are thermally softened or melted. The pressure between the glass plate and the polymer main body induces a material flow between the diaphragm and the polymer main body, which, after the solidification of the molten polymers, leads to a narrow, exactly positioned and mechanically very durable weld seam.

The polymer main body is precisely aligned on the positioning table by means of a centring apparatus consisting, for example, of 2 positioning pins 43, which fit into corresponding fitting holes on the main body, and is thereby brought into a fixed position (FIG. 9). The positioning table rests on four force sensors 42, which are embedded in the piston table, which is firmly connected to a cylinder. The four force sensors measure the forces applied to the four corners of the rectangular positioning table when the positioning table presses the polymer main body with the film tensioned over it against the glass plate 35 from below. The force distribution can be adjusted by means of four screws 41a, 41b, 41c, 41d at the corners (FIG. 7), which are fastened in the positioning table 36 via a thread. The screws reduce or increase the distance between the positioning table and the piston table so that the contact pressure at that point is reduced or increased, thus ensuring that the contact pressure is distributed evenly over the entire polymer main body.

The radiation source 31 is positioned at a distance with a certain focus position plane-parallel to the chip 37, so that the focus of the laser is either on or close to the plane spanned by the polymer main body and film. The closer the focus of the laser is to this plane, the narrower the weld seam becomes and the lower the beam power of the laser can be. The focus position also determines the energy input into the polymer body and the diaphragm film at the positions to be welded and thus the accuracy of the welding process. The focus position can either be fixed or variably adjusted via an axis system with the axes 32 and 33, which allows the laser to be moved perpendicularly to the arrangement of the polymer main body with film.

The polymer body 37 and the diaphragm 44 are pressed from below via the cylinder 39 against a glass plate 35, which has a high spectral transmission in the wavelength range of the laser. Especially in a wavelength range of 1940 nm, glass is highly suitable as a material for pressing the polymer body against the diaphragm film, since glass only minimally absorbs electromagnetic radiation in the near infrared range below 3 μm wavelength. This glass plate is fixed by a frame or tensioning collar 34 and oriented parallel to the radiation source 31. The distance is also determined by the focus position of the laser on the polymer body 37.

By means of an axis system with the axes 32 and 33, the radiation source 31 can be moved parallel to the polymer main body 37 and thus traverse the contours to be welded. The power and rate of advance of the laser can be variably adjusted.

The movement of the cylinder 39 relative to the radiation source 31 is realised via at least two axes 32 and 33, which move either the cylinder 39 via a traveling table 45 or the radiation source 31 in space.

The flexible diaphragm 44 can be tensioned in parallel over the microfluidic main body 37 by means of a bracing apparatus.

The flexible diaphragm can be tensioned in various ways. In order to achieve a plane-parallel application of the film on the glass plate to the best possible extent, it is possible to etch micro channels 46 into the glass plate 35 (FIG. 10 with the vacuum chamber 47 made of glass) via selective laser etching (Meineke et al. 2016), thus making it possible to create a vacuum in these channels by a connected vacuum pump and thus to suck the flexible diaphragm against the glass plate (FIG. 11) before the microfluidic main body is pressed against it. This reduces unevennesses of the flexible diaphragm.

Another tensioning option uses magnets which are embedded in the piston table. The film is pre-tensioned by hand over the main body and then held in place by further oppositely poled magnets. The magnets are mounted on a fixable rail that can be moved in one direction so that the diaphragm film can be stretched further and then fixed in the desired position (FIG. 4). This increases the tensioning precision.

Other ways of tensioning the flexible diaphragm are pneumatic cylinders. Here, the diaphragm is fixed on one side (e.g. with magnets), then tensioned over the main body and fixed on the opposite side with a pneumatic cylinder, this cylinder being fixed on an orthogonally mounted further cylinder, so that the diaphragm can be further stretched or tensioned by extending the cylinder in the x direction with defined force development. This results in a homogeneous tension over the entire welding area.

The polymer main body contains microstructures which, in their entirety, form a plurality of pumps and valve systems in interaction with the diaphragm film. A large number of valves, pump chambers and channels, as well as inlets and outlets, create a microfluidic array which enables the transport of liquid or gas from fluid inlets individually to the microreactors.

Such an array can consist of an actuator terminal block, as described in the European patent EP3055065, and the microreactor array with integrated microfluidic chip. The microfluidic chip consists of valves consisting of a spherical segment with a concentric line seal and a flexible diaphragm. Microchannels lead to the centre of the valve and to the circumference of the spherical segment. The flexible diaphragm can be moved via an actuator and can be closed and opened.

The control of the individual diaphragm valves can be realised by different methods. Among others, pneumatic control channels are possible here, but optically, thermally, hydraulically, electromechanically or magnetically activated switches can also be used for fluid channel control.

One possibility is to create a peristaltic movement, in which the fluid is first pressed through the inlet into the open inlet valves and the open pump chamber. By subsequently closing the inlet valves, a precise volume of fluid is trapped within the pump chamber. By opening an outlet valve and closing the pump chamber, the volume of the pump chamber can be conveyed in the direction of the channel outlet (FIGS. 1 to 3. The volume conveyed is largely determined by the precision of the pump chamber, which is generated from the structure of the polymer body and the covering by the diaphragm film. With this technique it is also possible to control a plurality of fluidic channels via one inlet and one pump chamber (FIG. 11).

The described invention significantly increases the precision of the valve covering; primarily, it reduces the variation in the volume of the volume enclosed by the valve trough and cover film, thus improving the precision of the dosing process. The mechanistic reason for this is that laser transmission welding allows a more precise geometry of the weld edge—or weld seam. This is achieved by a strictly locally limited energy input and thus softening of the substrate only at precisely defined points or along precisely defined seams. An unintentional relevant heat transfer outside the defined areas, especially an energy input into the pump/valve trough is thus almost completely avoided.

The polymer body (m2p-labs GmbH, Baesweiler, MTP-MF32-BOH 1 from Topas®) is fixed on the positioning table as described and the diaphragm film (Topas® ELASTOMER E-140, 100 μm thickness) is tensioned over the area to be welded. An example of the valve contour before welding is shown in FIG. 12. Using a CAD program (e.g. Autodesk AutoCAD), a corresponding weld contour is created (e.g. FIG. 13 weld contour). This weld contour can then be loaded into the welding program. The speed of travel at individual points, the beam power and the position for activating and deactivating the laser can also be set. The body to be welded is then pressed against the glass plate 35 via the cylinder (Festo ADN-100-60-A-P-A) at a pressure of 0.1 to 5 bar, preferably 0.75 bar. Too high a pressure causes the diaphragm film to deform and be pressed into the valves. Too low a pressure slows down the flow of material within the weld seam and thus reduces the strength of the weld seam. By reading out the force sensors (ME-Messtechnik KM26), it is ensured that the force distribution is homogeneous or must be readjusted via the adjusting screws. An inhomogeneous force distribution leads to an inhomogeneous focusing of the laser.

For welding, a thulium fibre laser of the company “IPG Laser” with the wavelength 1940 nm can be used. This wavelength is suitable because the polymer used (COC, cycloolefin copolymer; a copolymer of norbornene and ethene) is absorbent in this wavelength range. A corresponding optical system with a focal length of 20 mm focuses the laser beam. Depending on the rate of advance, a laser power of 2 to 50 W is required for the welding process; 5 to 25 watts at a rate of advance of the laser of 10 mm/min to 2000 mm/min are preferred, and 8 watts at a feed rate of 200 mm/min are particularly preferred. The required moderate laser power allows the choice between a large number of lasers, such as a thulium fibre laser from Keopsys (CW_Laser CTFL-TERA) or the IPG laser (TLM-200 Thulium CW Fiber Laser Module).

However, the method described here can be used not only for COC (Topas®) but also for other polymers that absorb in the infrared range. Examples are polystyrene, polymethyl methacrylate, polycarbonate, polyethylene etc.

The radiation source can be moved over the welding area in x, y and z direction via an axis system (e.g. Bosch Rexroth linear systems) in order to move the individual valve, channel and pump contours at a speed of, for example, 200 mm/min at a laser power of approximately 8 W. The laser beam is only activated here at the designated contours, thus avoiding unwanted energy input. With a focal length of 20 mm, the radiation source is positioned at a height of approximately 17 mm relative to the polymer body surface. This height must be adjusted by changing the focal length. In order not to melt the channels by increased local energy input, the weld contour must be generated at a precise distance from the channel of approximately 0.3 mm FIG. 14 shows a valve contour with weld seam.

The flexible diaphragm is softened only at the points where the laser beam penetrates and is connected to the main body by thermal fusion. Due to the high travel speed of the radiation source, melting of the valve or channel contours is prevented and the weld seam is defined. A variation of the beam power can further influence this seam. A high precision of the valve contour can thus be achieved by a sufficient accuracy of the axis system. This is directly reflected in the precision of the dosing process.

To measure the precision of the flow, the microfluidic chip is adhesively bonded as the bottom of a 48-well microtiter plate in an air- and liquid-sealed manner. The microtiter plate is placed on an orbital shaker, which mixes the liquids inside the microtiter plate at up to 1500 rpm (revolutions per minute). The transparency of the polymer bottom or microfluidic chip allows optical measurements of the liquid inside each individual reaction chamber. For example, fluorescence signals of green fluorescent protein, fluorescein or riboflavin can be detected. Such a measurement setup is implemented in the BioLector Pro from m2p-labs GmbH, Baesweiler, Germany.

To measure the flow rate, a mixture of 50 mM aqueous buffer solution (K2HPO4) was filled with 70 μM fluorescein via the channel input of the microfluidic chip described in EP3055065. Using an optical waveguide and corresponding optical filters with an excitation wavelength of 436 nm and a detection wavelength of 540 nm and the evaluation electronics of the BioLector Pro from m2p-labs, even the smallest changes in fluorescence in the reaction chambers above the microfluidic plate can be detected. The fluorescein-containing buffer solution is conveyed from the channel inlet in the reservoir well to the channel outlet in the reaction chamber via the described actuator of the pumping process. In the reaction chamber, 800 μL of a buffer solution consisting of 50 mM K2HPO4 is supplied. The BioLector Pro has 16 reservoir wells and 32 reaction chambers. From each reservoir well, solution can be conveyed through the bottom of the microfluidic plate into four reaction chambers. If the same fluorescein-containing buffer solution is filled into all reservoir wells and all pumps and valves in the microfluidic chip are controlled in the same way, the fluorescein solution is conveyed in the same way into all 32 reaction chambers. This arrangement thus makes it possible to check whether all pumps and valves that deliver the fluorescein solution from the reservoir wells to the reaction vessels convey the fluorescein solution in the same way and uniformly. This can be quantified by measuring the intensity of the fluorescence of the fluorescein pumped from the reservoir wells into the reaction chambers at regular intervals in all reaction chambers and by determining the change in fluorescence over time. This measurement can also be performed fully automatically in the BioLector Pro. With 0.5 bar pneumatic pressure, the liquid is pumped into the microfluidic channel via the inlet valves and the pump chamber to the outlet valves. The inlet valves close at 2 bar. Opening the outlet valves allows the fluorescein solution to enter the corresponding associated reaction chamber. By closing the pump chamber at 2.5 bar, the liquid is conveyed into the corresponding reaction chamber. The outlet valve is then also closed pneumatically at a pressure of 1.5 bar. This pumping process is repeated continuously for all 32 reaction chambers, resulting in a flow of 5 μL/h per reaction chamber.

Over a period of about 20 h, the change in the fluorescence signal of all 32 reaction chambers of the microtiter plate is recorded. After completion of the measurement, the mean value of the change in the fluorescence signal of all 32 measured values and the corresponding standard deviation as well as the relative standard deviation are determined. If all microfluidic pumps in the chip have been controlled in the same way, an identical flow rate into all 32 reaction chambers would be expected, and accordingly a standard deviation of zero. Higher standard deviations are an indicator for differences between the pumps or their control, which result in variations of the flow rate.

The test was carried out several times both with microfluidic chips where the diaphragm film is applied by thermofusion, and with microfluidic chips where the diaphragm film has been connected to the polymer main body by laser welding. The results show for the microfluidic chips manufactured by laser welding, compared to the microfluidic chips manufactured by thermofusion bonding, a significant increase of the precision of the pumping process, or rather a significant reduction of the standard deviation of the gradient of the fluorescence signal. The relative standard deviation of the change in the fluorescence signal over time was 12% on average in the case of chips produced by thermofusion bonding; for laser-welded chips it was less than 7% on average.

The above-mentioned components as well as components claimed and described in the embodiments to be used in accordance with the invention are not subject to any special exceptional conditions with regard to their size, shape, design, material choice and technical concepts, and therefore the selection criteria known in the field of application can be applied without restriction.

1. A method for increasing the dosing precision of microfluidic pumps 1, 2, 3 or valves which have a flexible diaphragm (4) and a valve body (8) with at least one valve trough (5, 6, 7), the flexible diaphragm (4) being attached to the valve body (8) in order to cover the valve trough (5, 6, 7), wherein the surface (9) of the diaphragm (4) facing the valve trough (5, 6, 7) is heated with a laser beam.

2. The method according to claim 1, wherein the diaphragm (4) is welded to the valve body (8) by means of the laser beam.

3. The method according to claim 1, wherein the diaphragm (4) or the valve body (8) is provided with a heat-activatable adhesive.

4. The method according to claim 1, wherein the laser beam is used to produce an attachment of the diaphragm (4) to the valve body (8) as a seam along the edge of the valve trough (5, 6, 7).

5. The method according to claim 1, wherein the surface of the diaphragm (4) facing the valve trough (5, 6, 7) is heated by radiation impinging on the diaphragm (4).

6. The method according to claim 5, wherein the radiation impinges on the surface (9) through the diaphragm (4).

7. The method according to claim 5, wherein the radiation impinges on the surface (9) through the valve body (8).

8. The method according to claim 1, wherein the surface (9) of the valve body (8) is polished before the attachment.

9. The method according to claim 1, wherein the surface (9) of the valve body (8) is plasma etched before the attachment.

10. The method according to claim 1, wherein the surface (9) of the valve body (8) is etched with an ion beam before the attachment.

11. The method according to claim 1, wherein the surface (9) of the valve body (8) is smoothed by a chemical modification before the attachment.

12. The method according to claim 1, wherein the surface (9) of the valve body (8) is hydrophilized hydrophilized before the attachment.

13. The method according to claim 1, wherein the surface (9) of the valve body (8) has a mean roughness value (Ra value) of less than 100 nm, preferably less than 50 nm and very preferably less than 20 nm, prior to the attachment around the valve trough (5, 6, 7).

14. The method according to claim 1, wherein the pump is designed to deliver liquids with flow rates between 0.01 μL/h and 1 ml/h, but particularly with flow rates between 0.01 and 100 μL/h and very particularly in the range of 0.1 to 80 μL/h.

15. The method according to claim 1, wherein the pump for the delivery of liquids operates with a pump volume per pump stroke between 5 nL/stroke and 1 μL/stroke, but particularly with a pump volume between 25 nL/stroke and 500 nL/stroke and very particularly in the range of 75 to 250 nL/stroke.

16. The method according to claim 1, wherein the inaccuracy of the guidance of the laser beam in the x-y direction is more than 0.05 micrometers and less than 1 micrometer, preferably less than 50 micrometers and very preferably less than 5 micrometers.

17. The method according to claim 1, wherein different polymers with different transmission ranges are used for the diaphragm (4) and the valve trough (5, 6, 7) and are welded with UV laser, visible laser beams or with infrared laser.

18. The method according to claim 1, wherein the wavelength range of the laser beam is between 0.1 and 1000 micrometers, preferably between 0.4 and 50 micrometers and very preferably between 0.78 and 3 micrometers.

19. The method according to claim 1, wherein the power of the laser beam is between 0.01 and 1000 watts, preferably between 0.1 and 100 watts and very preferably between 3 and 50 watts.

20. The method according to claim 1, wherein the attachment is performed over a line whose width is between 20 micrometers and 3 micrometers, preferably between 30 and 500 micrometers and particularly preferably between 50 and 300 micrometers.

21-22. (canceled)
